(19) United States
(12) Patent Application Publication
(10) Pub. No.: US 2017/0225989 A1
(43) Pub. Date: Aug. 10, 2017

(54) BIOMEDIATION METHOD

(71) Applicants: Kent C. Armstrong, Andover, NH (US); Ivan Richard Schaffner, Goffstown, NH (US)

(72) Inventors: Kent C. Armstrong, Andover, NH (US); Ivan Richard Schaffner, Goffstown, NH (US)

(21) Appl. No.: 15/474,775

(22) Filed: Mar. 30, 2017

Related U.S. Application Data
(63) Continuation of application No. 14/247,982, filed on Apr. 8, 2014, now abandoned.
Application No. 14/247,982 is a continuation of application No. 13/850,117, filed on Mar. 25, 2013, now abandoned.
Application No. 13/850,117 is a continuation of application No. 12/870,363, filed on Aug. 27, 2010, now abandoned.

(51) Int. Cl. C02F 3/28; C02F 3/00

(52) U.S. Cl. CPC C02F 3/28; C02F 3/006; C02F 2103/06

(57) ABSTRACT

A method for enhancing in situ bioremediation of a volume containing groundwater and a quantity of contaminant, the method comprising the steps of: quantifying the mass of the contaminant; and amending the volume by adding thereto a compound that provides a source of NO₃⁻. The method is characterized in that the compound is added such that the mass of the NO₃⁻ source is provided at the ratio of about 1 mg NO₃⁻ per 0.21 mg contaminant. The contaminant can be BTEX or petroleum-related VOC.

### REFERENCE TO PENDING APPLICATION

This application is a continuation application based on U.S. patent application Ser. No. 14/247,982, filed Apr. 8, 2014 entitled “Biomediation Method” which is a continuation application based on U.S. patent application Ser. No. 13/850,117, filed Mar. 25, 2013 entitled “Biomediation Method” which is a continuation application based on U.S. patent application Ser. No. 12/870,363, filed Aug. 27, 2010 entitled “Biomediation Method”.

### BACKGROUND OF THE INVENTION

### Field of the Invention

The remediation of contaminated soil and groundwater is an important industrial process. In this regard, petroleum-related volatile organic compounds (VOCs) represent a large area of concern. VOC contamination in soil typically forms a source mass that dissolves into the groundwater at varying rates. These dissolved-phase hydrocarbons can pose risks to human or environmental receptors at concentrations well below solubility limits. Accordingly, ambient groundwater quality standards are in place in many jurisdictions, and regulatory bodies regularly request or require “site cleanup” in situations where the VOC concentration in groundwater is found to exceed certain regulatory levels.

Known approaches for the reduction of groundwater VOC include systems that enhance existing microbial degradation by increasing the availability of dissolved oxygen to microbes existing in the groundwater and soil. For instance, an in situ oxygen curtain can be applied to the contaminated site which diffuses oxygen into the site groundwater. However, oxygen curtain systems have limitations, and, with large spills or high concentrations of VOCs, a significant improvement in groundwater quality cannot be obtained as a result of associated mass transfer limitations. It is thought that the remediation mechanism associated with oxygen addition is stimulation of the aerobic metabolic pathway within bacteria and other microbes; the oxygen serves as an electron acceptor, to accept the electrons released during VOC metabolism, which ultimately transforms the VOC source mass to carbon dioxide, water and microbial biomass.

Similarly, addition of nitrates to groundwater has been attempted. The increase in nitrate content is thought to stimulate the anaerobic metabolic pathway within bacteria and other microbes, serving as an electron acceptor, analogous to the oxygen added to enhance the aerobic pathway. Reaction products from the anaerobic pathway include carbon dioxide, water, microbial biomass and nitrogen gas. However, excess nitrate concentration in groundwater causes its own environmental problems, including blooms of algae in receiving surface waters. Thus, addition of nitrates to groundwater is discouraged; the risk of VOC contamination is deemed preferable to the risk of excess nitrate in the groundwater and surrounding receiving waters.

### SUMMARY OF THE INVENTION

Forming one aspect of the invention is a method for enhancing in situ bioremediation of a volume containing groundwater and a quantity of petroleum-related VOC contaminant, the method comprising the steps of:
quantifying the mass of the contaminant;
(ii) amending the volume by adding thereto a compound that provides a source of NO₃⁻

characterized in that the compound is added such that the mass of the NO₃⁻ source is provided at the ratio of about 1 mg NO₃⁻ per 0.21 mg contaminant.

According to another aspect of the invention, the compound can be selected from anhydrous ammonia, urea, ammonium sulfate, ammonium nitrate, potassium nitrate and sodium nitrate.

According to another aspect of the invention, the compound can be selected from anhydrous ammonia, urea, ammonium sulfate, ammonium nitrate, potassium nitrate and sodium nitrate.

According to another aspect of the invention, the compound can be potassium nitrate or sodium nitrate.

According to another aspect of the invention, the method can further comprise the steps:
(iii) monitoring the concentration of the contaminant in the groundwater in the volume until it stabilizes; and
(iv) repeating steps (i)-(iii) until the desired level of decontamination has been achieved.

A method for enhancing in situ bioremediation of a volume containing groundwater and a quantity of a BTEX contaminant, the method comprising the step of:
quantifying the mass of the contaminant;
   (ii) amending the volume by adding thereto a compound that provides a source of NO₃⁻ characterized in that the compound is added such that the mass of the NO₃⁻ source is provided at the ratio of about 1 mg NO₃⁻ per 0.21 mg contaminant.

According to another aspect of the invention, the compound can be selected from anhydrous ammonia, urea, ammonium sulfate, ammonium nitrate, potassium nitrate and sodium nitrate.

According to another aspect of the invention, the nitrogen compound is potassium nitrate or sodium nitrate.

According to another aspect of the invention, the method can further comprise the steps:
(iii) monitoring the concentration of the contaminant in the groundwater in the volume until it stabilizes; and
(iv) repeating steps (i)-(iii) until the desired level of decontamination has been achieved.

Forming yet another aspect of the invention is a method for enhancing in situ bioremediation of an earthen volume containing groundwater and a quantity of a contaminant, the contaminant selected from one or more of

| | | |
|---|---|---|
| benzene | toluene | ethylbenzene xylene |
| alkylbenzene | naphthalene | methyl tertiary butyl ether |
| 1,2,4 trimethylbenzene | | 1,3,5 trimethylbenzenen- |
| Propylbenzene | n-butylbenzene | p-isopropyltoluene |

the method comprising the step of:
(i) quantifying the mass of the contaminant;
(ii) amending the volume by adding thereto a compound that defines a source of NO₃⁻, characterized in that the compound is added such that the mass of the NO₃⁻ source is provided at the ratio of about 1 mg NO₃⁻ per 0.21 mg contaminant;
(iii) monitoring the concentration of the contaminant in the groundwater in the volume until it stabilizes; and
(iv) repeating steps (i)-(iii) until the desired level of decontamination has been achieved.

According to another aspect of the invention, the nitrogen compound can be selected from anhydrous ammonia, urea, ammonium sulfate, ammonium nitrate, potassium nitrate and sodium nitrate.

According to another aspect of the invention the nitrogen compound can be potassium nitrate or sodium nitrate.

Other advantages, features and characteristics of the present invention will become more apparent upon consideration of the following detailed description and the appended claims.

### BRIEF DESCRIPTION OF THE DRAWINGS

FIG. 1 shows a plan view of a bioremediation site.

### DETAILED DESCRIPTION OF THE PREFERRED EMBODIMENTS

It has been found that the addition of NO₃⁻ salts that enhance denitrification decreases the dissolved-phase hydrocarbons in the groundwater system, and, even more surprisingly, decreases the VOC source mass present. It has also been found that addition of denitrification agents can be made in a controlled manner which minimizes or eliminates excess groundwater NO₃⁻ concentration. The appropriate amount of denitrification agent to be added can be determined, by balancing the reaction stochiometry, calculating the amount of source mass and other electron donor sinks, and deliberately underloading the denitrification agent such that a sufficient amount is provided to decrease the groundwater dissolved-phase hydrocarbon concentration (and/or the VOC source mass) while minimizing the residual nitrates present after such remedial action. Such minimizing of residual nitrates prevents or minimizes the formation of algae blooms in receiving surface waters and other potential undesirable environmental effects of NO₃⁻ salt amendment.

Injection of NO₃⁻ salts is found to be advantageous, as compared to traditional methods involving injection of oxygen, for a number of reasons. NO₃⁻ salts have aqueous solubility limits that are orders of magnitude greater than oxygen, which allows for supply/addition of much higher amounts of NO₃⁻, much more easily than the injection of oxygen. NO₃⁻ salts are relatively low cost, and can be delivered via a low-technology injection approach such as Direct Push Technology equipped with a grout pump.

Because smaller microbial population densities are expected through the use of a denitrification enhancement agent (as compared to use of oxygen, given denitrification is less metabolically efficient than aerobic respiration), biofouling problems are typically less significant than the oxygen pathway. Other advantages are that NO₃⁻ supplies the inorganic nutrient, Nitrogen, which may further stimulate microbial activity, and that, because denitrification consumes hydrogen ions, NO₃⁻ respiration may also elevate groundwater pH. Given VOC-degrading bacteria can become inhibited under low pH conditions, especially within petroleum hydrocarbon plumes, where biogenic carbon dioxide produced during hydrocarbon metabolism produces carbonic acid (which depresses pH), the consumption of hydrogen ions, which elevates pH and enhances microbial metabolism.

Interestingly, because addition of oxygen contributes to the aerobic metabolic pathway, and addition of NO₃⁻ contributes to the anaerobic pathway, synergistic remediation methods wherein both oxygen and NO₃⁻ are added can be advantageous. Likewise, since the addition of NO₃⁻ contributes to the anaerobic pathway of most if not all anaerobic bacteria, synergistic remediation methods wherein both the addition of exogenous bacteria and NO₃⁻ are added can be advantageous.

“Contaminated groundwater”, as it is used in this description, is meant to include all sources of groundwater that have been contaminated by volatile organic compounds and/or allied chemicals.

“Denitrification enhancement agent” includes any substance known to enhance denitrification by indigenous soil bacteria. This includes compounds that are sources of NO₃⁻,such as NO₃⁻ salts, NO₂, NO, and/or N₂O. Denitrification has a relatively high redox potential, and is the next step down the terminal electron acceptor ladder from molecular oxygen. Denitrification can yield kinetic degradation rates on the order of aerobic mineralization. NO₃⁻ respiration is the anaerobic metabolic analog to oxygen respiration, and oxidized nitrogen species serve as the terminal electron acceptor under anaerobic conditions, to collect the electrons released by the anaerobic metabolic cycle. Denitrification occurs under anoxic conditions in which NO₃⁻, organic carbon, and, of course, soil bacteria are present. During denitrification, NO₃⁻ is ultimately transformed to molecular nitrogen (N₂) through the following simplified reaction:

2NO₃⁻10e⁻+12H⁺--->N₂+6H₂O

Denitrifying bacteria can also respire nitrite (NO₂), nitric oxide (NO), and nitrous oxide N₂O). Because NO₃⁻ has the highest oxidation state (+5, as compared to +3, +2 and +1, respectively for NO₂, NO and/or N₂O), a source of NO₃⁻ is the preferred denitrification enhancement agent.

“NO₃⁻ salts” mean any salts of NO₃⁻, whether in salt or ionized form. NO₃⁻ salts include but are not necessarily limited to potassium nitrate and sodium nitrate.

“Volatile Organic Compounds” include any petroleum-based products and products derived from petroleum, that are volatile or semi-volatile in nature and biodegradable, and include the petroleum hydrocarbons benzene, toluene, ethylbenzene, any form of xylene, any form of alkylbenzene, including 1,2,4 trimethylbenzene, 1,3,5-trimethylbenzene, n-propylbenzene, n-butylbenzene, p-isopropyltoluene and other hydrocarbons.

### EXAMPLES

### Example 1

### Nitrate Amendment to Contaminated Groundwater

Groundwater sampling was performed at a site known to be contaminated with VOCs. Samples of groundwater were collected from a groundwater well and the following baseline parameters were measured: VOC concentration, NO₃⁻ concentration, level of dissolved oxygen (DO), pH, specific conductance, and temperature. Samples were also collected from four groundwater wells monitoring wells at varying distances from the primary performance well.

Immediately after baseline sampling, a Passive Release Sock (PRS) containing about three pounds of sodium nitrate (Concord Crop Center, Concord, N.H.) was deployed below the top of the water column and straddling the well screen of the monitoring well. The PRS consisted of a 5 foot long, 1.5 inch outer diameter filter fabric sock, sealed at each end, constructed to release NO₃⁻ salt into the well bore upon hydration during deployment. About 1 pound of clean filter sand was added at the bottom of the PRS to provide negative ballast to position the PRS below the water level in the well bore during deployment.

Groundwater samples at the five wells were collected at 22, 36 and 50 days following deployment of the PRS. One additional set of groundwater samples was collected at 14 days following PRS removal to evaluate rebound intervals. At the 22 and 36 day time points, the PRS was observed to be completely depleted of NO₃⁻ salt, so fresh sodium nitrate was added to the PRS, following sampling, so that amendment of NO₃⁻ salt would continue. At the 50 day time point, the PRS was removed, so that at the 63 day time point reflected a two-week stabilization period during which NO₃⁻ salts amendments were not being made to site groundwater.

Groundwater samples from baseline and post PRS-deployment sampling rounds were transported in accordance with standard Chain of Custody protocol to a state-certified laboratory for analysis. An aliquot of each groundwater sample was analyzed in the field at the time of sample collection for Dissolved Oxygen, pH, specific conductance, and temperature, using parameter-specific electrodes.

Results for the primary performance well are summarized in Table 1; more detailed results can be found in Table 4.

TABLE 1
Summary of Groundwater VOC Data

| | Baseline | 50 days | | 64 days |
|---|---|---|---|---|
| VOC | (μg/L) | (μg/L) | % reduction | (μg/L) |
| Total BTEX* | 386 | 0.0 | 100 | 7.7 |
| Total VOCs | 542.5 | ND | 100 | 10.3 |
| Total | 114.9 | <1.0 | 100 | ND |
| Alkylbenzenes | | | | |
| Benzene | 9.8 | <1 | 100 | 3.0 |
| Naphthalene | 21 | <1.0 | 100 | <2.0 |

*BTEX = benzene, toluene, ethylbenzene, and total xylenes.
**ND = Not detectable

NO₃⁻ salt amendment via the PRS achieved a 100% reduction in gross VOC concentrations. Significantly, following removal of the PRS, there was rebound for most performance metrics, due to source mass still being present in the formation and dissolving into the groundwater. This indicated that the reductions summarized in Table 1 were likely directly attributable to enhanced dentrification driven by NO₃⁻ salt amendment.

Results from another monitoring well closest to the PRS deployment well initially showed a spiked increase in total BTEX and total VOC at 22 days following PRS deployment, after which decreasing concentrations of both BTEX and total VOC were observed until 50 days, with minimal rebound at 64 days. The monitoring well furthest from the PRS deployment well did not show any effect of denitrification likely due to the de minimus loading of the PRS.

The results from the secondary well closest to the primary well (Well 2) are summarized in Table 2.

TABLE 2
Well 2 results

| | Baseline | 50 days | |
|---|---|---|---|
| VOC | (μg/L) | (μg/L) | % reduction |
| Total BTEX* | 2451 | 867 | 65 |
| Total VOCs | 3511 | 1798 | 49 |
| Total | 887.6 | 694 | 22 |
| Alkylbenzenes | | | |
| Benzene | 54 | 22 | 59 |
| Naphthalene | 120 | 170 | −42 |

The results for the well second-closest to the PRS deployment well (Well 3) are summarized in Table 3.

TABLE 3
Well 3 results

| | Baseline | 50 days | |
|---|---|---|---|
| VOC | (μg/L) | (μg/L) | % reduction |
| Total BTEX* | 7034 | 876 | 88 |
| Total VOCs | 9749 | 1418 | 85 |
| Total | 2245 | 390 | 83 |
| Alkylbenzenes | | | |
| Benzene | 73 | 18 | 75 |
| Naphthalene | 310 | 100 | 68 |

PRS deployment generally resulted in significant reductions in VOC concentrations for contaminants of concern at the deployment and both downgradient monitoring well locations. Exceptions included a 42% increase in naphthalene concentration in Well 2. The reason for this increased concentration is unclear, but may represent analytical variability given that the baseline concentrations for this compound was one of the lowest detected of the entire baseline data set.

Total BTEX and total VOC concentrations were observed to rebound in both Well 2 and Well 3 at 64 days (14 days following end of treatment and removal of the PRS), indicating that the enhanced denitrification was the cause of the decreased concentration in these compounds observed during the study.

Wells 4 and 5 were too distant to be influenced by the NO₃⁻ salt administration via PRS at Well 1, especially given the de minimus amount of NO₃⁻.

As discussed above, in addition to measurement of VOCs, various indicator parameters were also measured.

### pH

Over the course of the 50 days, an overall increase in pH of about 0.5 to 1 standard unit was observed in groundwater samples collected from the primary well and from the secondary well closest to the primary well (Well 2). Since non-assimilatory NO₃⁻ reduction consumes hydrogen cations, the increased pH conditions at these wells provide a corroborating line of evidence that the denitrification petroleum hydrocarbon degradation pathway was driven by the NO₃⁻ salt amendment at the PRS deployment well. Only marginal increases in pH were noted at wells 4 and 5; these increases were likely not caused by the application of NO₃⁻ salt.

### Specific Conductivity

An overall increase in specific conductivity, beyond the instrument's range of detection, was observed in groundwater samples collected at day 22 at the PRS deployment well; this increase in specific conductivity was observed throughout the remaining sample times and is consistent with NO₃⁻ salt amendment. A 31% increase in specific conductivity was also observed in Well 2 and is also consistent with NO₃⁻ salt amendment. There was no significant change in specific conductivity at Wells 3 and 4, and a decrease in specific conductivity was observed at Well 5.

### Temperature

There was an overall increase in temperature throughout the study, likely due to the seasonal change from spring to summer. The temperature increase was seen in all wells. The temperature remained within a range suitable for microbial metabolism throughout the study.

### Nitrates

Groundwater samples collected at the PRS deployment well immediately following NO₃⁻ amendment detected NO₃⁻ concentrations of over 20,000 mg/l. By 22 days, this level had dropped to less than 50 ug/l, suggesting that the NO₃⁻ was largely used up as the preferred terminal electron acceptor by denitrifying soil bacteria during petroleum hydrocarbon metabolism. Quite surprisingly, a 6 order of magnitude rebound in NO₃⁻ concentration was observed at 36 days, at the primary well. This rebound is consistent with residual source mass destruction. If only dissolved-phase petroleum hydrocarbons were destroyed and no residual source mass, NO₃⁻ concentrations would be expected to decrease consistently following each administration of NO₃⁻ as the NO₃⁻ was scavenged by residual source mass. Thus, this “rebound” is surprising evidence that administration of NO₃⁻ to groundwater not only breaks down the dissolved-phase petroleum hydrocarbons, but also the residual source mass.

Also surprising, the NO₃⁻ concentration at the site of PRS deployment was back to near normal levels just 2 weeks after the removal of the PRS (day 64). Note that the level of NO₃⁻ in the groundwater, both at the primary well 2 weeks after the removal of the PRS and at all secondary wells at all times was below the Ambient Groundwater Quality Standards for NO₃⁻, (currently set at <10,000 ug/l), even though more than 20,000 mg/l was measured in the groundwater immediately following PRS deployment. This demonstrates that, surprisingly, NO₃⁻ amendment can be controlled and managed to be protective of groundwater quality when used appropriately. Most surprisingly, the addition of NO₃⁻ salt to groundwater destroys residual source mass, and should not contribute to algae bloom in receiving surface waters, since the levels of NO₃⁻ salt return to background just 2 weeks following amendment.

### Post Phase 1

Monitoring was continued. Ongoing Phase 1 monitoring data indicated a slight rebound of petroleum hydrocarbon concentrations 6-12 months post nitrate amendment injection indicating the partial destruction and/or presence of residual source mass sorbed to the surface of site phreatic zone soil grains. Consistent with prediction, nitrate was not detected above analytical laboratory reporting limits, consistent with the results of the first phase of pilot testing.

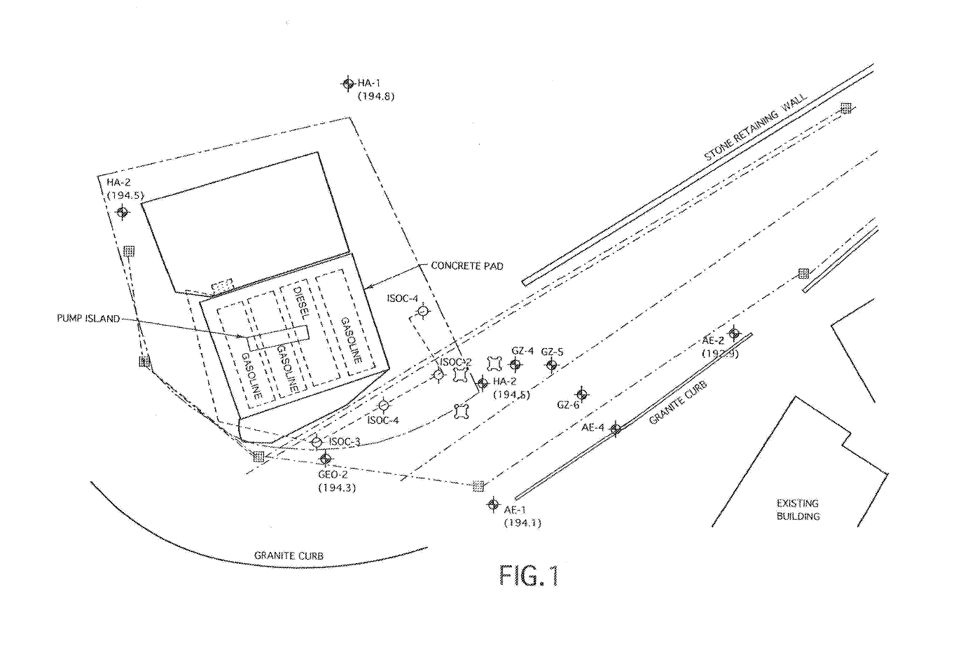

Following on the success of Phase 1, the project was taken to Phase 2, namely, large-scale nitrate salt injection according to the present invention. A map showing the injection and monitoring wells is shown as FIG. 1 and the aggregated monitoring results of Phase 1 and Phase 2 are appended as Appendix A.

At well HA-4 an increase of nitrate salt concentrations in the groundwater of the petroleum-contaminated phreatic zone was observed. A similar increase was rapidly observed in downgradient monitoring wells GZ-4, GZ-5 and GZ-6 (listed in accordance with distance from injection area (around well HA-4).

Shortly thereafter, petroleum hydrocarbon concentrations are initially observed to increase as nitrate concentrations begin to decrease. Without intending to be bound by theory, this is believed to result from increased bioactivity of heterotrophic soil bacteria, namely, release of hydrocarbon desolubilizing enzymes, during the initial metabolism of petroleum constituents.

Subsequently, both nitrate salt and concentrations for the majority of petroleum metrics evaluated begin to significantly decrease, the exceptions being MtBE and benzene.

Benzene and MtBE migrate rapidly and this extended plume is believed to be representative of differential migration rates; however, trends (as like those above) ultimately reverse indicating a steady decrease in concentrations of both contaminants with additional nitrate reduction. As persons of ordinary skill in the art will readily appreciate, these results suggest that both contaminant and nitrate salt concentrations will ultimately attain concentrations reported as BDL.

The results were most pronounced at well GZ-4; wells GZ-5 and GZ-6 demonstrate similar patterns, but at lower orders of magnitude due to distance from injection area (HA-4)

1. A method for enhancing in situ bioremediation of a volume containing groundwater and a quantity of petroleum-related VOC contaminant, the method comprising the steps of:
quantifying the mass of the contaminant;
(ii) amending the volume in situ by adding thereto a compound that provides a source of NO₃⁻
characterized in that the compound is added such that the mass of the NO₃⁻ source is provided at the ratio of about 1 mg NO₃⁻ per 0.21 mg contaminant.

2. A method according to claim 1, wherein the compound is selected from anhydrous ammonia, urea, ammonium sulfate, ammonium nitrate, potassium nitrate and sodium nitrate.

3. A method according to claim 1, wherein the compound is potassium nitrate or sodium nitrate.

4. A method according to claim 1, further comprising the steps:
(iii) monitoring the concentration of the contaminant in the groundwater in the volume until it stabilizes; and
(iv) repeating steps (i)-(iii) until the desired level of decontamination has been achieved.

5. A method for enhancing in situ bioremediation of a volume containing groundwater and a quantity of a BTEX contaminant, the method comprising the steps of:
quantifying the mass of the contaminant;
(ii) amending the volume in situ by adding thereto a compound that provides a source of NO₃⁻
characterized in that the compound is added such that the mass of the NO₃⁻ source is provided at the ratio of about 1 mg NO₃⁻ per 0.21 mg contaminant.

6. A method according to claim 5, wherein the compound is selected from anhydrous ammonia, urea, ammonium sulfate, ammonium nitrate, potassium nitrate and sodium nitrate.

7. A method according to claim 5, wherein the nitrogen compound is potassium nitrate or sodium nitrate.

8. A method according to claim 5, further comprising the steps:
(iii) monitoring the concentration of the contaminant in the groundwater in the volume until it stabilizes; and
(iv) repeating steps (i)-(iii) until the desired level of decontamination has been achieved.

9. A method for enhancing in situ bioremediation of an earthen volume containing groundwater and a quantity of a contaminant, the contaminant selected from one or more of

| | |
|---|---|
| benzene | toluene |
| ethylbenzene | xylene |
| alkylbenzene | naphthalene |
| methyl tertiary butyl ether | 1,2,4 trimethylbenzene |
| 1,3,5 trimethylbenzene | n-propylbenzene |
| n-butylbenzene | p-isopropyltoluene |

the method comprising the steps of:
(i) quantifying the mass of the contaminant;
(ii) amending the volume in situ by adding thereto a compound that defines a source of NO₃⁻, characterized in that the compound is added such that the mass of the NO₃⁻ source is provided at the ratio of about 1 mg NO₃⁻ per 0.21 mg contaminant;
(iii) monitoring the concentration of the contaminant in the groundwater in the volume until it stabilizes; and
(iv) repeating steps (i)-(iii) until the desired level of decontamination has been achieved.

10. A method according to claim 9, wherein the nitrogen compound is selected from anhydrous ammonia, urea, ammonium sulfate, ammonium nitrate, potassium nitrate and sodium nitrate.

11. A method according to claim 9, wherein the nitrogen compound is potassium nitrate or sodium nitrate.

12. A method according to claim 2, further comprising the steps:
(iii) monitoring the concentration of the contaminant in the groundwater in the volume until it stabilizes; and
(iv) repeating steps (i)-(iii) until the desired level of decontamination has been achieved.

13. A method according to claim 6, further comprising the steps:
(iii) monitoring the concentration of the contaminant in the groundwater in the volume until it stabilizes; and
(iv) repeating steps (i)-(iii) until the desired level of decontamination has been achieved.

14. A method according to claim 1 wherein the source of NO₃⁻ is in salt form.

15. A method according to claim 5 wherein the source of NO₃⁻ is in salt form.
